(19) United States
(12) Patent Application Publication
(10) Pub. No.: US 2009/0089315 A1
(43) Pub. Date: Apr. 2, 2009

(54) SYSTEM AND METHOD FOR ASSOCIATING METADATA WITH ELECTRONIC DOCUMENTS

(75) Inventors: Scott R. Jeffery, Chattanooga, TN (US); Thomas A. Rizk, Franklin Lakes, NJ (US)

Correspondence Address: PERKINS COIE LLP;PATENT-SEA, P.O. BOX 1247, SEATTLE, WA, 98111-1247, US

(73) Assignee: TractManager, Inc., Chattanooga, TN (US)

(21) Appl. No.: 11/864,571

(22) Filed: Sep. 28, 2007

(51) Int. Cl. G06F 17/30

(52) U.S. Cl. 707/102; 707/E17.044

(57) ABSTRACT

A computer hardware/software facility for managing electronic documents receives metadata globally attributable to a plurality of electronic documents and searches the electronic documents to acquire or generate metadata locally attributable to the plurality of electronic documents. The global and local metadata are organized into an intermediate file, which is displayed in an editable format. The intermediate file is used to generate a database encoding the electronic documents and associated metadata.

### BACKGROUND

In a business acquisition, it is common for an acquirer to receive a large number of documents that allow the acquirer to assess the business's value. For instance, an acquirer may receive copies of contracts, accounting records, property deeds, maintenance records, employee information, client contact information, instruction manuals, research materials, and so on, related to the business. Such documents help the acquirer to determine, for example, the revenue and expenses of the business, as well as the business's ability to protect its assets and carry out its existing objectives and obligations. Due to the importance of these documents, due diligence document inspections play a significant role in business acquisitions.

Unfortunately, businesses often maintain documents in a form that makes it burdensome for potential acquirers to perform such inspections. For example, a business may maintain large stores of paper documents in a physical filing system, or the business may maintain electronic documents in an electronic file organization that is unfamiliar or not readily-informative to the potential acquirers. As a result, potential acquirers may be required to spend a significant amount of time searching through and organizing the documents in order to accomplish their inspection objectives. This may delay deals and drive up transactions costs.

To illustrate some potential difficulties associated with conventional due diligence inspections of electronic documents, FIG. 1 shows a set of electronic documents such as those that might be generated by an apartment complex or commercial building. The electronic documents are maintained in a conventional file tree structure 100 in which the documents have been grouped by a user. The illustrated groups distinguish electronic documents based on how they relate to a rough set of categories such as rental rolls, taxation, and utilities.

While the file tree 100 provides a minimal amount of organization to the documents, unfortunately the file tree conveys little information regarding the relevance, importance, or specific content of each electronic document. For example, file tree 100 fails to provide users with an integrated view of the documents' collective content so that the users can compare details of related documents. Accordingly, by looking at file tree 100 alone, it is difficult for a potential acquirer to determine how to best focus a due diligence inspection. Oftentimes, when confronted with such a situation the potential acquirer must complete the time-consuming process of opening and examining each document. By inspecting each document in this way, the potential acquirer may spend significant time reviewing unimportant information, and may fail to grasp certain details regarding critical information. Accordingly, improved technologies for managing documents are needed to better facilitate document inspections.

### BRIEF DESCRIPTION OF THE DRAWINGS

FIG. 1 illustrates a collection of electronic documents organized in a conventional file tree structure.

FIG. 2 is a block diagram of an environment in which a system may operate to manage electronic documents.

FIG. 3 is a flowchart of a method of associating metadata with electronic documents in order to help manage the documents.

FIG. 4 illustrates an example interface used to designate inputs and outputs for the system adapted to manage electronic documents.

FIG. 5 illustrates an example intermediate data file produced by the system to enable an operator to modify metadata associated with electronic documents.

FIGS. 6A-6C illustrate an example interface for displaying information pertaining to electronic documents and associated metadata.

### DETAILED DESCRIPTION

A system and method to facilitate the management of a large number of electronic documents is disclosed. The system and method allow metadata to be easily associated with a large number of electronic documents as the electronic documents are being imported into a database. The metadata may be automatically or manually generated, organized, and updated. The metadata and associated electronic documents are stored in a convenient database format in order to allow the documents and/or metadata to be searched and accessed in the future. The system and method speeds the importation of a large number of electronic documents such as those generated by scanning paper documents. The system and method also reduces the difficulty associated with managing a large number of electronic documents by allowing searchable metadata to be associated with the documents.

The disclosed system and method allows an operator, such as a human user or a third party application, to import electronic documents from one location and store the documents in another location. During the import process, the operator may observe, validate, and/or update metadata associated with the imported electronic documents. The operator may specify new metadata that should be associated with electronic documents, and may establish relationships between the metadata and electronic documents. In some embodiments, for those documents that are stored in an optically-scanned or other image format, the system may perform optical character recognition on the document and generate searchable text that corresponds to the document. The searchable text may be stored in association with the electronic document.

The disclosed system and method may also allow an operator to subsequently manage the imported electronic documents in aggregate. Even though the operator may have specified changes to the metadata during the import process, subsequent use of the imported electronic documents may require large-scale changes be made to the metadata. The system and method disclosed herein allow such changes to be made by an operator using a simple interface that allows quick comparisons and changes across the corpus of electronic documents.

The system and method find ready application in a wide variety of data processing platforms (i.e., combination computer hardware and/or software facilities), including, for example, personal computers, personal digital assistants (PDAs), and networked computer systems. In addition, some embodiments of the invention may be used to process any of several different types of electronic documents and/or related data, including, for example, image files, word processing files, and spreadsheet documents.

For illustrative convenience, and to highlight potential benefits of certain embodiments, specific types of data processing platforms, electronic documents, and related data will be discussed in the description that follows. For instance, in some examples provided below, electronic documents related to business relationships are processed in response to interactions of an operator with a personal computer (PC) via a graphical user interface. However, it should be understood that different types of platforms, documents, and/or related data may be used without departing from the scope of the invention.

Further examples of certain document types and data processing platforms that may be used within the context of selected embodiments are provided in related and commonly assigned U.S. Pat. No. 7,194,677 entitled “Method and System to Convert Paper Documents to Electronic Documents and Manage the Electronic Documents,” which is incorporated herein in its entirety by this reference.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

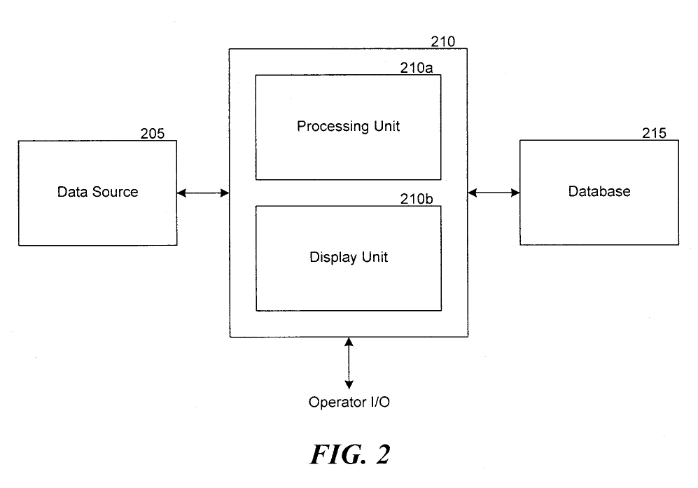

FIG. 2 is a block diagram of an environment in which a data processing system 210 may be used by an operator to import and manage electronic documents. Data processing system 210 facilitates the importation of electronic documents from a data source 205 and storage of the electronic documents with associated metadata in a database 215. Data processing system 210 also facilitates the modification of metadata associated with electronic documents stored in database 215. For example, data processing unit 210 displays metadata in a human editable form such as a spreadsheet to allow a user to view and modify the metadata. Data processing system 210 comprises a processing unit 210a and a display unit 210b, the functionality of which will be described in additional detail herein.

Although shown as three separate elements in FIG. 2, the data source 205, data processing system 210, and database 215 may each be implemented within a single device or system, or across multiple systems that are physically or logically separated. Indeed, it should be recognized that the physical, logical, and conceptual parsing or aggregating of their respective implementations and/or functions into various units of hardware and/or software may be made in any manner. Accordingly, the logical separation of these elements and their respective functions as illustrated in FIG. 2 should not be viewed as limiting the scope of the corresponding embodiments.

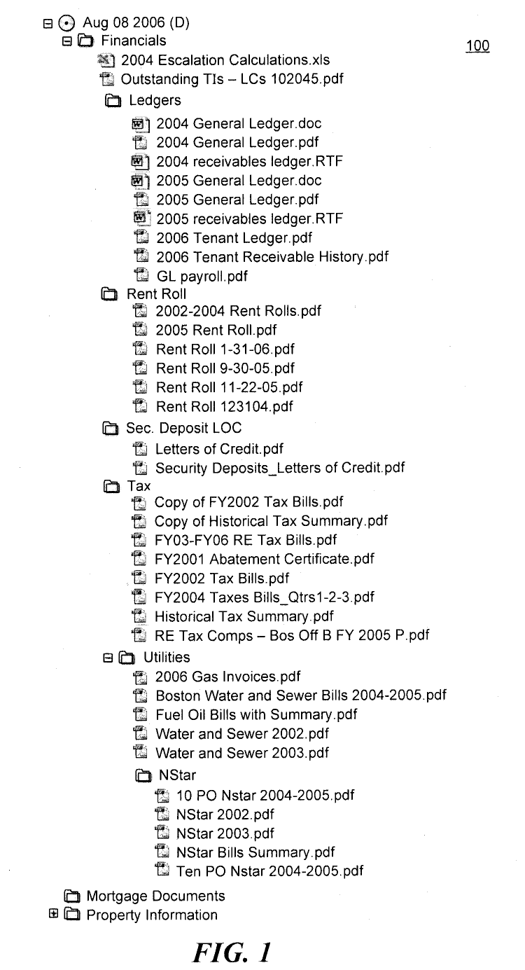

Data source 205 contains a collection of electronic documents. The electronic documents stored in data source 205 may include, e.g., image files generated by scanning or otherwise imaging paper documents, word processing files, plain text files, indexed, tagged, or otherwise specially formatted or encoded data files, and so on. The electronic documents could be organized, for example, in a structure such as file tree 100 shown in FIG. 1. Data source 205 may be embodied by any of several data storage and/or transfer facilities including, for example, computer-readable media such as memory disks or chips, compact disks or digital video disks, remote data repositories, portable memory sticks, and so on.

Typically, electronic documents in data source 205 are associated with one or more units of metadata. One unit of metadata associated with an electronic document is a unique name for the document. Other metadata associated with a document may indicate the document's location within data source 205, such as the name(s) of one or more folders or other file structure in which the electronic document resides. Still other metadata may be associated with an electronic document, such as information regarding the time and date when the document was generated or last modified, the author or originator of the document, a revision history of the document, a brief description of the document's contents or subject matter, the size of the document, etc. In addition to metadata, each document may also be characterized by the actual content (e.g., the text or graphics) contained in the document.

Each unit of metadata contained in data source 205 or derivable from the electronic documents can be considered to be “globally attributable” to the documents, or “locally attributable” to the documents. Metadata that is globally attributable to the electronic documents (i.e., “global metadata”) contains information that can be ascribed to the collection of electronic documents as a whole (i.e., to each of the electronic documents within the entire collection). Metadata that is locally attributable to the electronic documents (i.e., “local metadata”) contains information that can be ascribed to individual documents or subsets of the documents smaller than the whole collection.

As may be appreciated in view of the description that follows, the metadata associated with a document or collection of documents may be useful in performing operations for effectively managing, organizing, displaying, and/or storing the documents. In general, the metadata associated with the documents stored in data source 205 may be identified through an automatic process or through manual input, editing, curation, or encoding of the documents, or by some combination of automatic and manual processes.

In some embodiments, the electronic documents in data source 205 are organized in a hierarchical structure. For example, the documents may be organized in a folder/sub-folder structure. Alternatively, the electronic documents could be organized in other structures such as linked or otherwise related, but not necessarily hierarchical structures. For example, the electronic documents could be organized in some form of queue, array, hash table, linked list, or arbitrary file tree structure.

Data processing system 210 communicates with data source 205 to access the electronic documents. Within data processing system 210, processing unit 210a stores data and performs logical operations for accessing, transferring, and processing the electronic documents. In some embodiments, processing unit 210a can analyze electronic documents stored in data source 205. The analysis can be accomplished while the collection of electronic documents still resides in data source 205, e.g., without copying the entire set of documents into data processing system 210, or it can be accomplished after the documents have been copied or transferred from data source 205.

In analyzing the electronic documents, processing unit 210a identifies metadata related to the documents. Through the analysis process, or subsequent thereto, processing unit 210a extracts some or all of the identified metadata from data source 205, together with an indication of the electronic documents associated with the metadata, such as file pointers for those documents and/or the documents themselves.

Once processing unit 210a has searched through the electronic documents in data source 205 and has extracted metadata associated with documents as described above, processing unit 210a generates an intermediate file that contains the extracted information. In some embodiments, the intermediate file comprises a spreadsheet that contains each unit of metadata together with an indication of its corresponding electronic document, e.g., the document name or a pointer to the document.

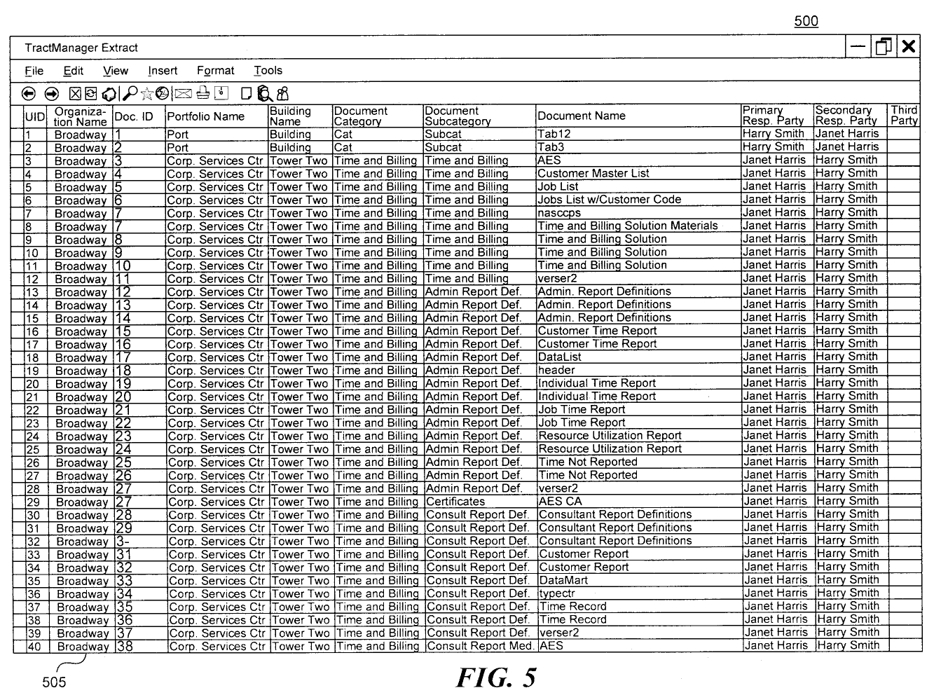

After processing unit 210a generates the intermediate file, the intermediate file is displayed in an editable form by display unit 210b. Preferably, the display of the intermediate file will be such that an operator can effectively examine the electronic documents and their associated metadata in order to verify and/or update the documents and/or metadata for purposes such as accuracy and/or relevance. An example of such an intermediate file displayed as a spreadsheet is provided in FIG. 5, the details of which are described in further detail herein.

In some embodiments, the intermediate file may be used as part of a supervised process for creating a customized document management database from the electronic documents. By allowing an operator to examine metadata associated with electronic documents in aggregate, as well as to verify, edit, and update such metadata, the system allows a customized document management database to be created that greatly facilitates management of the documents. In other words, the intermediate file provides an integrated view of the documents that greatly enhances a user's ability to inspect and modify associated metadata. FIG. 5, which is described in further detail below, illustrates an example intermediate file comprising a spreadsheet. In the spreadsheet, data pertaining to business documents is displayed such that each row of the display contains information related to the contents and subsequent handling of each document. If, based on a visual analysis of the displayed spreadsheet, an operator determines that some of the documents or related information should be omitted from or modified in the customized document management database, the desired change can be readily achieved by the operator by editing the spreadsheet.

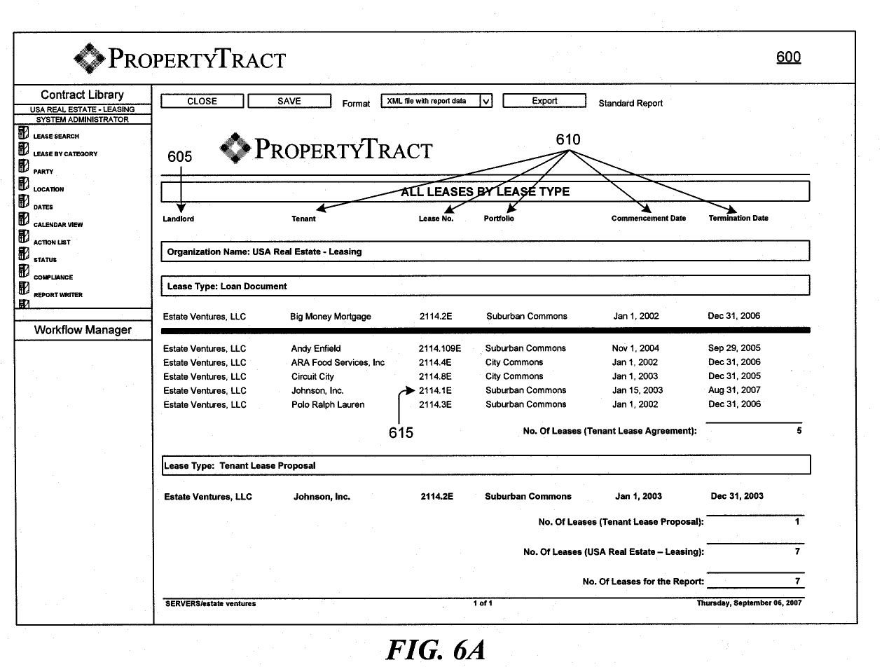

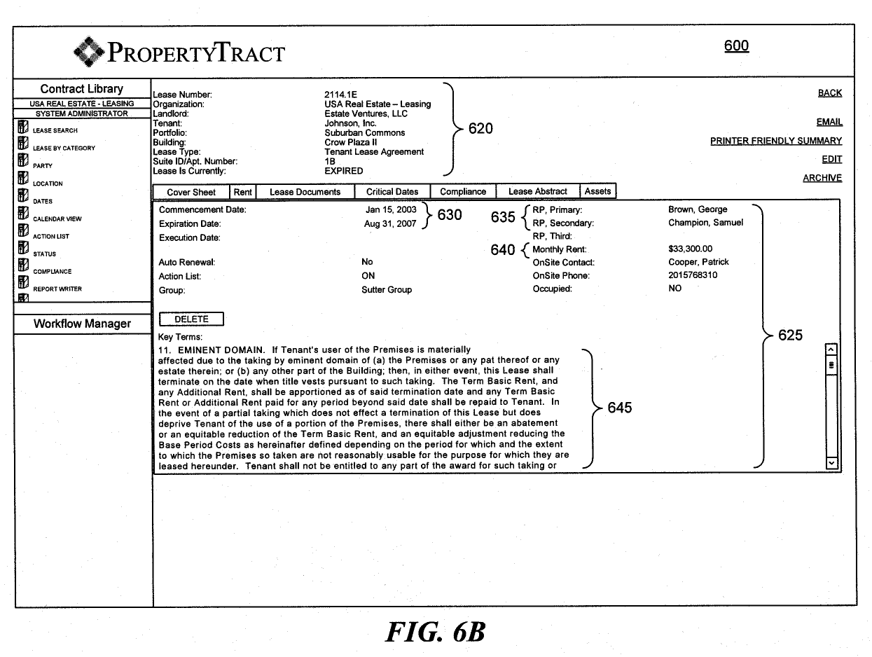

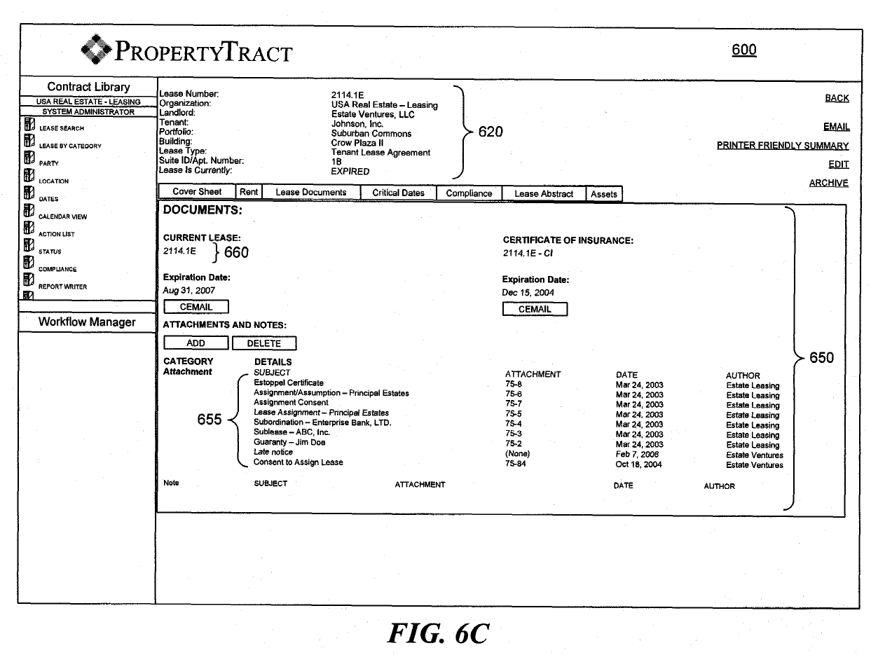

FIGS. 6A through 6C, also described in further detail below, illustrate an example program displaying information from a document management database generated by a system such as data processing system 210. In FIGS. 6A through 6C, metadata is displayed in an organized form allowing users to better inspect various properties and relationships among electronic documents. The addition of metadata enables operators to quickly locate and analyze single documents or groups of documents that are relevant to the desired analysis (e.g., a corporate acquisition or audit). The disclosed system and method therefore decreases costs and improves efficiencies when managing electronic documents.

As shown in FIG. 2, data processing system 210 provides an operator input/output (I/O) interface to allow an operator such as a human user or a device to send and/or receive instructions for the operation of the data processing system. For instance, the I/O interface may provide tools such as a keyboard and/or mouse to allow a human user to edit the intermediate file displayed by display unit 210b.

Once the intermediate file has been displayed by display unit 210b, an operator may provide inputs or instructions to system 210 to populate the database 215 with the electronic documents stored in data source 205 and with the derived or received metadata. In general, database 215 is constructed from a combination of the data presented to the operator in the intermediate file, data derived from the stored electronic documents, and the electronic documents themselves. For those documents that are stored in an optically-scanned or other image format, the system may also perform optical character recognition on the documents and generate searchable text that corresponds to the documents. The searchable text may be stored in association with the electronic documents. The data in database 215 is organized or structured to facilitate the retrieval of desired data through queries to the database. For instance, assuming that database 215 is constructed to include metadata regarding the corporate business documents used in the example of FIG. 5, a query could be constructed to retrieve documents for which the “Primary Responsible Party” field has a value “Harry Smith.” By allowing an operator to apply queries against both the stored documents as well as the metadata associated with the documents, the system greatly facilitates the management of a large number of documents.

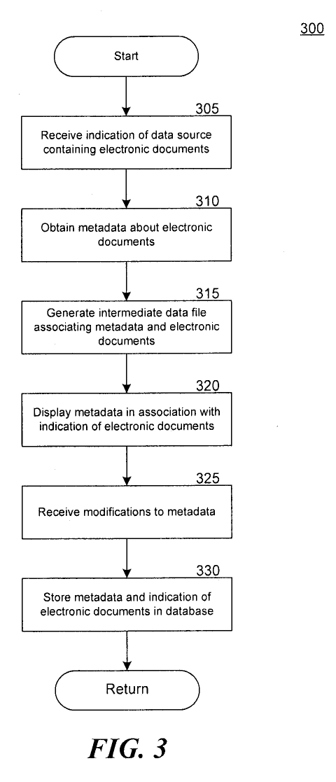

FIG. 3 is a flowchart illustrating a process 300 of importing electronic documents implemented by the data processing system 210. For convenience, it will be assumed that the process of FIG. 3 is performed in a system similar to that illustrated in FIG. 2. However, as noted above, the system illustrated in FIG. 2 could be modified in any of several ways; similarly, the method of FIG. 3 could be modified in any of several ways and could be performed by any of a variety of different systems. In several embodiments, the process is performed through the operation of a software application program running on a computing system.

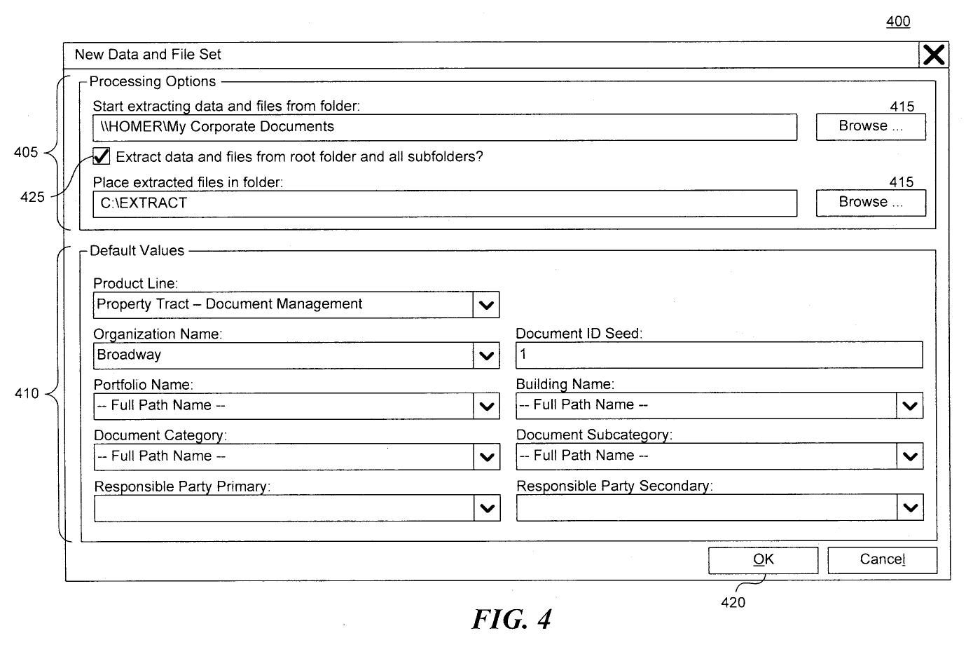

At a block 305, the system receives an indication of the location on the data source that contains the collection of electronic documents to be processed. As noted previously, the electronic documents are typically stored in a data storage area. An operator is therefore allowed to specify the location of documents to be processed by the system. FIG. 4 is a representative interface 400 that allows an operator to specify the location where the electronic documents may reside. A “Processing Options” region 405 at the top of the interface allows the operator to provide a network or system path to the file folder that contains the electronic documents. For example, the specified path \\Homer\My Corporate Documents includes the root-level location of a tree of electronic documents to be analyzed. The operator is also presented with a checkbox 425 to select the option to extract electronic documents from all subfolders that are contained in the specified root folder. If the box is checked, the entire document tree will be extracted and processed. Otherwise, only documents in the root level will be extracted and processed. The operator is thereby allowed to quickly and easily select a corpus of documents that are to be processed. It will be appreciated that other ways of specifying the documents to be processed may be alternatively used, such as selecting files in a list, identifying removable storage media (e.g. a CD or DVD) that contains the documents, etc.

The interface 400 also allows an operator to specify a location to place the extracted files. The “Processing Options” region 405 includes a field to allow the user to specify the network or system path of where files are to be stored. For example, the depicted entry indicates that the files will be stored at the path “C:\EXTRACT”. Browse buttons 415 are provided to allow the operator to browse to available storage locations if a path is not immediately known.

Returning to FIG. 3, at a block 310 metadata attributable to the stored collection of electronic documents is obtained by the data processing system 210. Typically, metadata is obtained in two ways. In a first way, the system may allow an operator to specify metadata that globally applies to the imported documents. The metadata may be received from the operator by an interactive graphical user-interface, an input data file, or through an input command line. Metadata globally attributable to the collection of electronic documents may comprise, for example, a “type” of the electronic documents, the name of an organization to which the documents corresponds, and so on. For example, the interface in FIG. 4 includes a “Default Values” region 410 that allows the operator to specify global metadata that is to be associated with the imported electronic documents. In this example, the global metadata to be applied to the documents is specified using a number of drop-down menus. One menu labeled “Product Line” allows the operator to specify a discrete portion of a business to which the electronic documents are related, a second menu labeled “Organization Name” allows the operator to specify the business's name, a third menu labeled “Document ID Seed” and several other menus relate to information such as the type of documents, the physical location of documents, persons responsible for the documents, and so on. An operator may elect to assign values for each item of metadata or may elect to leave certain metadata unspecified. The type and form of metadata depicted in FIG. 4 is exemplary, and a greater or lesser number of metadata items may be presented by the system to an operator. Moreover, the type of metadata may vary significantly based on the particular application in which the system is being used. Once the operator has assigned values to all items of metadata that they wish to enter, the operator selects an “OK” button 420 to initiate the importation process.

In a second way of obtaining metadata, metadata may be automatically derived by the system from data that is associated with the stored electronic documents. For each document, such metadata includes a file name, the location of the file in a file storage structure, a name of associated file folders in the file structure, a create date of the file, an author of the file, etc. In addition, the system may analyze the data within each document to identify metadata attributable to the document or to the collection of documents. Metadata derived by the system may be global (e.g., the root file folder may provide a corporate name that should be associated with all imported documents) or the metadata may be local (e.g., the name of a particular file may represent the contents of the associated document).

After the system has gathered metadata attributable to the imported electronic documents, at a block 315 the system generates an intermediate file that associates the metadata (either local or global) with the electronic documents. The intermediate file is formatted in a manner that allows the data in the file to be displayed to an operator in a way that the relationship between each document and the corresponding metadata may be easily understood, e.g., via a graphical user interface.

After the intermediate file has been generated, at a block 320 the system displays the intermediate file in a human-editable form such as in a graphical user interface. The editable display allows an operator to inspect, modify, supplement, or delete the metadata associated with each electronic document. The display can be used as a way of facilitating manual inspection, annotation, and curation of the collection of electronic documents. FIG. 5 is a representative interface 500 that allows an operator to view metadata associated with documents in the intermediate file. The interface is a spreadsheet comprising several columns, each column corresponding to a unit of metadata. The spreadsheet further comprises several rows, each row corresponding to a unique electronic document. In the example depicted in FIG. 5, only the value in an organization name column 505 is globally applied to all electronic documents. The values in other columns correspond to local metadata.

At least some of the local metadata shown in FIG. 5 is derived from the names of the electronic documents and associated folders in which the electronic documents were originally stored. In other words, as in many practical file systems, the electronic documents may have been manually or automatically organized in folders and sub-folders in a structure indicative of various properties of the documents. For instance, an electronic document identified by “Document ID=3” (third row of FIG. 5) and named “AES” may have been contained in the following file location before importation: “\\Homer\My Corporate Documents\Corporate Services Center\Tower Two\Time and Billing”. As seen in FIG. 5, this file location may be disassembled to identify local metadata values that are then applied to the corresponding electronic document. For example, the “Portfolio Name” may be assigned the value “Corporate Services Center” for the document. Accordingly, the organization and naming of files and folders in the data source 205 may be automatically used to generate local metadata values.

Once presented with interface 500, an operator may review, revise, reconcile, and validate the values presented in the spreadsheet. The operator may make block changes to metadata application to multiple documents or may make changes to the metadata of a single document. The operator may utilize the sorting and filtering capability of the spreadsheet to confirm that appropriate documents are correlated with appropriate metadata, such as confirming that the responsible party is associated with a group of documents. Returning to FIG. 3, at a block 325 the system receives any modifications to the metadata from the operator. While the spreadsheet may generally allow an operator to modify any of its values, in some embodiments, certain values may be displayed in a read-only, i.e., un-modifiable form, to prevent the operator from making any modifications to those values.

Once satisfied with the metadata, the operator may instruct the system to produce a database file that includes the metadata as well as copies of or links to the electronic documents. In a broad sense, the database may be organized or structured to facilitate retrieval of desired data through queries presented to the database through a program such as a database management system. At a block 330, the system receives an instruction from the operator indicating that the metadata and electronic documents should be stored. The system them proceeds to translate the intermediate file data into an appropriate format for storing in the database 215. As part of the translation process, the system may also perform optical character recognition on any scanned or imaged document and generate searchable text that corresponds to the document. The searchable text may be stored in association with the electronic document.

Once stored in database 215, the electronic documents and metadata can be organized, processed, and displayed by software designed to interact with database 215. For example, FIGS. 6A-6C illustrate an example interface 600 of a database program used to access and display data stored in database 215. For convenience of illustration, it will be assumed that the data shown in FIGS. 6A-6C relates to the various documents illustrated in FIG. 1, although it should be noted that some information illustrated in FIG. 6 may be derived from documents not shown in FIG. 1. In this way, the examples of FIGS. 1 and 6 can be viewed as respective “before” and “after” views of data processed by data processing system 210.

In the illustration of FIG. 6A, the database program displays general information related to lease agreement documents. This data includes, for example, global metadata 605 such as a common landlord associated with each of the documents, and local metadata 610 such as individual tenants, lease and portfolio identifiers, and relevant dates. By displaying the data in this way, the database program allows a user to manage and monitor the documents more readily than when the documents are presented in a relatively unstructured form such as that illustrated in FIG. 1.

Interface 600 allows a user to click on embedded links to view more specific information related to particular lease agreement documents. For example, an embedded link 615 shown in FIG. 6A can be clicked to view specific details and documents related to a lease agreement document 2114.1E. These details and documents are available through different views illustrated in FIGS. 6B and 6C.

The interface depicted in FIGS. 6B and 6C both include a header 620. The header includes global metadata relating to a collection of lease agreements, such as an organization (USA REAL Estate—Leasing) and landlord (Estate Ventures, LLC) in charge of the lease agreements, as well as local metadata relating specifically to lease agreement document 2114.1E, such as a tenant name (Johnson, Inc.), a Suite ID (1B), and a status of the lease agreement (EXPIRED).

A body portion 625 of the interface in FIG. 6B shows information from a cover sheet including local metadata such as effective dates 630 of lease agreement document 2114.1E, primary and secondary responsible parties (RP) 635 for the lease agreement document, monthly rent 640 for the agreement, and so on. In addition, the body portion 625 is supplemented with information such as key terms 645 which may be valuable for interpreting documents related to the lease agreement document.

A body portion 650 of the interface in FIG. 6C provides a link 660 for accessing lease agreement document 2114.1E and links 655 for accessing documents related to lease agreement document 2114.1E. The related documents include, among others, a lease assignment document, and a sublease document. The relationship between the related documents and a lease agreement document 2114.1E may be determined, for example, based on the structure of file tree 100 or based on metadata such as “document subcategory” information in the table shown in interface 500.

From the examples of FIGS. 6A-6C, it should be appreciated that selected embodiments of the invention may improve a user's ability to manage a collection of electronic documents based on various properties of the documents and various types of metadata associated with the documents.

While various embodiments are described in terms of the environment described above, those skilled in the art will appreciate that various changes to the facility may be made without departing from the scope of the invention. For example, the term “database” is used herein in the generic sense to refer to any data structure that allows data to be stored and accessed, such as tables, linked lists, arrays, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the information functionality. Those skilled in the art will further appreciate that the steps shown in FIG. 3 may be altered in a variety of ways. For example, the order of the steps may be rearranged, substeps may be performed in parallel, steps may be omitted, or other steps may be included.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A computer-readable medium encoding instructions for performing a method in a data processing platform, wherein the method comprises:
receiving metadata globally attributable to a plurality of electronic documents;
retrieving metadata locally attributable to the plurality of electronic documents;
arranging the received and retrieved metadata into a display format wherein an association is displayed between the metadata and each of the plurality of electronic documents;
displaying the arranged metadata in a user-editable form in a graphical user interface;
receiving one or more edits from a user to the displayed metadata; and
generating a database file based on the displayed metadata, wherein the database file facilitates retrieval of the plurality of electronic documents using metadata associated with the electronic documents.

2. The computer-readable medium of claim 1, wherein the display format comprises a table having a plurality of rows and columns.

3. The computer-readable medium of claim 1, wherein the plurality of electronic documents are organized in a hierarchical file structure.

4. The computer-readable medium of claim 3, wherein the hierarchical file structure is a folder/sub-folder structure.

5. The computer-readable medium of claim 1, wherein the plurality of electronic documents comprise image documents encoding information from scanned paper documents.

6. The computer-readable medium of claim 5, wherein the method further comprises:
analyzing the plurality of electronic documents using optical character recognition and generating searchable text corresponding to the plurality of electronic documents; and
storing the searchable text in a database file, wherein the database file facilitates retrieval of the plurality of electronic documents using the searchable text associated with the electronic documents.

7. The computer-readable medium of claim 5, wherein the scanned paper documents comprise written contracts.

8. The computer-readable medium of claim 2, wherein each column of the table is associated with a single unit of metadata and each row of the table is associated with a single electronic document.

9. The computer-readable medium of claim 1, wherein receiving metadata globally attributable to the plurality of electronic documents comprises:
capturing the metadata globally attributable to the plurality of electronic documents from a user via a dialog box.

10. The computer-readable medium of claim 1, wherein retrieving metadata locally attributable to the plurality of electronic documents comprises:
searching the plurality of electronic documents to identify, for each of the electronic documents, at least one local metadata value corresponding to a local metadata field associated with the documents.

11. The computer-readable medium of claim 10, wherein the at least one local metadata value comprises a name for the corresponding electronic document.

12. The computer-readable medium of claim 10, wherein the at least one local metadata value comprises information derived from a storage path of the plurality of electronic documents.

13. The computer-readable medium of claim 10, wherein the information derived from the storage path of the plurality of electronic documents comprises names of folders and/or sub-folders within a hierarchical file tree.

14. The computer-readable medium of claim 1, wherein displaying the arranged metadata in a user-editable form comprises:
loading the arranged metadata into a spreadsheet program and displaying the arranged metadata as an electronic spreadsheet.

15. The computer-readable medium of claim 1, wherein displaying the arranged metadata in a user-editable form comprises:
displaying some metadata in a read-only form and displaying other metadata in an editable form.

16. A method for associating metadata with electronic documents to facilitate document management, comprising:
receiving metadata globally attributable to a plurality of electronic documents stored in a computer-readable media;
retrieving metadata locally attributable to the plurality of electronic documents;
arranging the received and retrieved metadata into a display format wherein an association is displayed between the metadata and each of the plurality of electronic documents;
displaying the arranged metadata in a user-editable form in a graphical user interface;
receiving one or more edits from a user to the displayed metadata; and
generating a database file based on the displayed metadata, wherein the database file facilitates retrieval of the electronic documents using metadata associated with the electronic documents.

17. The method of claim 16, wherein the display format comprises a table having a plurality of rows and columns.

18. The method of claim 16, wherein the plurality of electronic documents comprise image documents encoding information from scanned paper written contracts.

19. The method of claim 18, further comprising:
analyzing the plurality of electronic documents using optical character recognition and generating searchable text corresponding to the plurality of electronic documents; and
storing the searchable text in a database file, wherein the database file facilitates retrieval of the plurality of electronic documents using the searchable text associated with the electronic documents.

20. The method of claim 16, wherein receiving metadata globally attributable to the plurality of electronic documents comprises:
capturing the metadata globally attributable to the plurality of electronic documents from a user via a dialog box.

21. The method of claim 16, wherein retrieving metadata locally attributable to the plurality of electronic documents comprises:
searching the plurality of electronic documents to identify, for each of the electronic documents, at least one local metadata value corresponding to a local metadata field associated with the documents,
wherein the at least one local metadata field comprises a name for the corresponding electronic document, or wherein the at least one local metadata field comprises a storage path of the corresponding electronic document.

22. An electronic data processing platform, comprising:
a metadata acquisition component for receiving metadata globally attributable to a plurality of electronic documents stored in a computer-readable medium, and for retrieving metadata locally attributable to the plurality of electronic documents;
a display component for displaying the received and retrieved metadata in a display format wherein an association is displayed between the metadata and each of the plurality of electronic documents;
an editing component to receive one or more edits from a user to the displayed metadata; and
a storage component for generating a database file based on the displayed metadata, wherein the database file facilitates retrieval of the electronic documents using metadata associated with the electronic documents.

23. The electronic data processing platform of claim 22, wherein the plurality of electronic documents comprise image documents encoding information from scanned paper written contracts.

24. The electronic data processing platform of claim 23, further comprising an optical character recognition component for analyzing the plurality of electronic documents and generating searchable text corresponding to the plurality of electronic documents, wherein the searchable text is stored in the database file to facilitate the retrieval of the plurality of electronic documents.

25. The electronic data processing platform of claim 22, wherein the metadata acquisition component comprises:
a search component for searching the plurality of electronic documents to identify, for each of the electronic documents, at least one local metadata value corresponding to a local metadata field associated with the documents,
wherein the at least one local metadata field comprises a name for the corresponding electronic document, or wherein the at least one local metadata field comprises a storage path of the corresponding electronic document.
